(19) United States
(12) Patent Application Publication
(10) Pub. No.: US 2020/0075205 A1
(43) Pub. Date: Mar. 5, 2020

(54) IRON CORE-TYPE REACTOR HAVING GAPS

(71) Applicant: FANUC CORPORATION, Yamanashi (JP)

(72) Inventors: Kenichi Tsukada, Yamanashi (JP); Tomokazu Yoshida, Yamanashi (JP); Masatomo Shirouzu, Yamanashi (JP)

(73) Assignee: FANUC CORPORATION, Yamanashi (JP)

(21) Appl. No.: 16/550,652

(22) Filed: Aug. 26, 2019

(30) Foreign Application Priority Data
Aug. 29, 2018 (JP) 2018-160876

(51) Int. Cl. H01F 3/14; H01F 27/30

(52) U.S. Cl. CPC H01F 3/14; H01F 27/306

(57) ABSTRACT

A reactor includes an outer peripheral iron core, at least three leg part iron cores arrayed on an inner surface side thereof, each of which is composed of a laminate of a plurality of electromagnetic steel sheets, and coils wound on the respective leg part iron cores, wherein each of the at least three leg part iron cores is arranged so that one end thereof in the direction of a winding axis of the coil is magnetically connected to the outer peripheral iron core and the other end in the direction of the winding axis is magnetically connected to the other end of another of the at least three leg part iron cores via a gap, and at least one of the leg part iron cores includes a weld part for welding at least a part of the plurality of electromagnetic steel sheets in the lamination direction.

### BACKGROUND OF THE INVENTION

### 1. Field of the Invention

The present invention relates to a reactor, and in particular, relates to an iron core-type reactor having gaps.

### 2. Description of Prior Art

To date, reactors which comprise an outer peripheral iron core spanning the outer circumference thereof and at least three iron core coils which contact or are connected to the inside of the outer peripheral iron core, and in which each iron core coil is composed of an iron core and a coil wound around the iron core and is magnetically connected to another iron core coil adjacent thereto via a gap have been known. In such conventional reactors, when the iron cores are formed by laminating a plurality of electromagnetic steel sheets, there is a problem in that noise and vibration occur when the reactor is driven.

A three-phase reactor comprising a vibration suppression structure disposed near the gaps to suppress vibration generated in the gaps has been reported (e.g., Japanese Unexamined Patent Publication (Kokai) No. 2018-117047).

However, in the conventional reactor described in Japanese Unexamined Patent Publication (Kokai) No. 2018-117047, there is a problem in that in order to form the vibration suppressing structure, the number of components and the number of assembly steps are increased, which increases manufacturing cost.

### SUMMARY OF THE INVENTION

The present invention aims to provide a reactor that can suppress vibration generated in the vicinity of the gaps while reducing manufacturing cost as compared to conventional reactors.

The reactor according to an embodiment of the present disclosure comprises an outer peripheral iron core, at least three leg part iron cores which are arrayed in the circumferential direction in a space on an inner surface side of the outer peripheral iron core, each of which is composed of a laminate of a plurality of electromagnetic steel sheets, and coils wound on the respective at least three leg part iron cores, wherein each of the at least three leg part iron cores is arranged so that one end thereof in the direction of a winding axis of the coil is magnetically connected to the outer peripheral iron core and the other end in the direction of the winding axis is magnetically connected to the other end of another of the at least three leg part iron cores via a gap, and at least one of the leg part iron cores comprises a weld part for welding at least a part of the plurality of electromagnetic steel sheets in the lamination direction.

According to the reactor in the embodiment of the present disclosure, vibration generated in the vicinity of the gaps can be suppressed while reducing manufacturing cost as compared to conventional reactors.

### BRIEF DESCRIPTION OF THE DRAWINGS

FIG. 1 is a plan view of a reactor according to embodiment 1 of the present disclosure.

FIG. 2 is a perspective view of the reactor according to embodiment 1 of the present disclosure.

FIG. 3 is a perspective view of a part of the reactor according to embodiment 1 of the present disclosure when separated.

FIG. 4A is a plan view of the reactor according to embodiment 1.

FIG. 4B is a perspective view of the reactor according to embodiment 1.

FIG. 5A is a plan view of a reactor according to embodiment 2.

FIG. 5B is a perspective view of the reactor according to embodiment 2.

FIG. 6A is a plan view of a reactor according to embodiment 3.

FIG. 6B is a perspective view of the reactor according to embodiment 3.

FIG. 7A is a plan view of a reactor according to embodiment 4.

FIG. 7B is a perspective view of the reactor according to embodiment 4.

FIG. 8A is a plan view of a reactor according to embodiment 5.

FIG. 8B is a perspective view of the reactor according to embodiment 5.

FIG. 9 is a perspective view of a reactor according to embodiment 6.

### DETAILED DESCRIPTION

The iron-core type reactor having gaps according to the present invention will be described below with reference to the drawings. However, it should be noted that the technical scope of the present invention is not limited to these embodiments, but covers the inventions described in the claims and equivalents thereof.

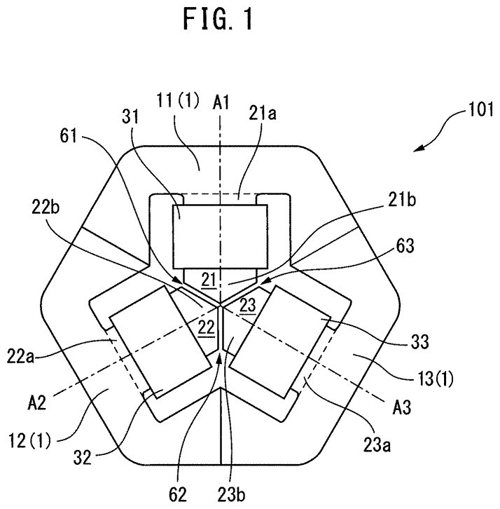

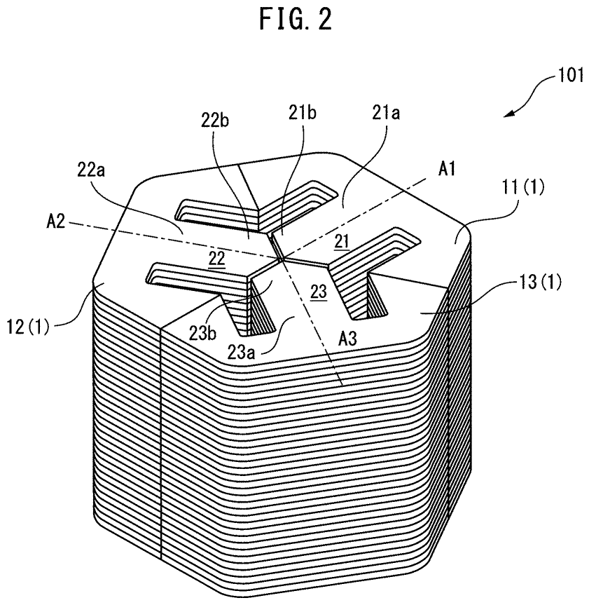

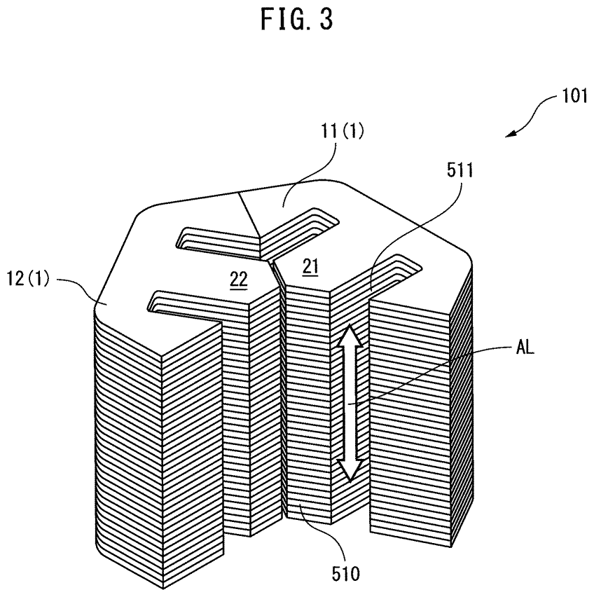

First, a reactor according to embodiment 1 of the present disclosure will be described. FIG. 1 is a plan view of a reactor 101 according to embodiment 1 of the present disclosure. FIG. 2 is a perspective view of the reactor 101 according to embodiment 1 of the present disclosure. FIG. 3 is a perspective view of a part of the reactor 101 according to embodiment 1 of the present disclosure when separated.

The reactor 101 according to embodiment 1 of the present disclosure comprises an outer peripheral iron core 1, at least three leg part iron cores (21, 22, 23), and coils (31, 32, 33) which are wound on the respective at least three leg part iron cores (21, 22, 23). The outer peripheral iron core 1 may be composed of a plurality of outer peripheral iron core portions (11, 12, 13). In the description below, the case in which the numbers of the leg part iron cores and the coils are three will be described as an example. However, the numbers of the leg part iron cores and the coils may be four or more.

The three leg part iron cores (21, 22, 23) are arrayed in the circumferential direction in a space on an inner surface side of the outer peripheral iron core 1, and are each composed of a laminate of a plurality of electromagnetic steel sheets. In FIG. 3, the lamination direction of the electromagnetic steel sheets is represented by arrow AL.

As shown in FIGS. 2 and 3, in embodiment 1, the first outer peripheral iron core portion 11 and the first leg part iron core 21 are integrally formed, the second outer peripheral iron core portion 12 and the second leg part iron core 22 are integrally formed, and the third outer peripheral iron core portion 13 and the third leg part iron core 23 are integrally formed. Thus, the outer peripheral iron core 1 also has a structure in which a plurality of electromagnetic steel sheets are laminated. Note that, in order to facilitate understanding of the contents of the invention, in the descriptions below, the illustration of parallel lines demonstrating that the outer peripheral iron core 1 and the leg part iron cores (21, 22, 23) have a laminated structure has been omitted.

As shown in FIG. 3, among the surfaces constituting the first leg part iron core 21, the surfaces (510, etc.) which form gaps between the first leg part iron core and the other leg part iron cores (22, 23) are referred to as “gap surfaces” and the two opposing surfaces (511, etc.) provided parallel to the winding axes of the coils are referred to as “side surfaces”. In the reactor according to the embodiment of the present disclosure, weld parts (described later) are provided on the side surfaces. The winding axis refers to the central axis when the coils (31, 32, 33) are wound on the leg part iron cores (21, 22, 23).

As shown in FIG. 1, the coils (31, 32, 33) are wound on the respective three leg part iron cores (21, 22, 23). Specifically, the first coil 31 is wound on the first leg part iron core 21, the second coil 32 is wound on the second leg part iron core 22, and the third coil 33 is wound on the third leg part iron core 23. Note that in order to facilitate understanding of the contents of the invention, in the drawings other than FIG. 1, illustration of the coils has been omitted. Furthermore, it is preferable to wind the coils on the leg part iron cores after completion of the welding processes of the leg part iron cores.

Each of the three leg part iron cores (21, 22, 23) is arranged so that one end (21a, 22a, 23a) thereof in the direction of the winding axis (A1, A2, A3) of the coil (31, 32, 33) is magnetically connected to the outer peripheral iron core 1. Specifically, the first leg part iron core 21 is arranged so that one end 21a thereof in the direction of the winding axis A1 of the first coil 31 is magnetically connected to the outer peripheral iron core portion 11. Likewise, the second leg part iron core 22 is arranged so that one end 22a thereof in the direction of the winding axis A2 of the second coil 32 is magnetically connected to the outer peripheral iron core portion 12. Likewise, the third leg part iron core 23 is arranged so that one end 23a thereof in the direction of the winding axis A3 of the third coil 33 is magnetically connected to the outer peripheral iron core portion 13.

Further, each of the three leg part iron cores (21, 22, 23) is arranged so that the other end (21b, 22b, 23b) thereof in the direction of the winding axis (A1, A2, A3) is magnetically connected to the other end of another of the three leg part iron cores via gaps (61, 62, 63). Specifically, the first leg part iron core 21 is arranged so that the other end 21b of the first leg part iron core 21 in the direction of the winding axis A1 is magnetically connected to the other ends 22b and 23b of the second leg part iron core 22 and the third leg part iron core 23 via the first gap 61 and the third gap 63, respectively. Likewise, the second leg part iron core 22 is arranged so that the other end 22b of the second leg part iron core 22 in the direction of the winding axis A2 is magnetically connected to the other ends 21b and 23b of the first leg part iron core 21 and the third leg part iron core 23 via the first gap 61 and the second gap 62, respectively. Likewise, the third leg part iron core 23 is arranged so that the other end 23b of the third leg part iron core 23 in the direction of the winding axis A3 is magnetically connected to the other ends 21b and 22b of the first leg part iron core 21 and the second leg part iron core 22 via the third gap 63 and the second gap 62, respectively. The sizes of the gaps 61 to 63 are preferably equal to each other.

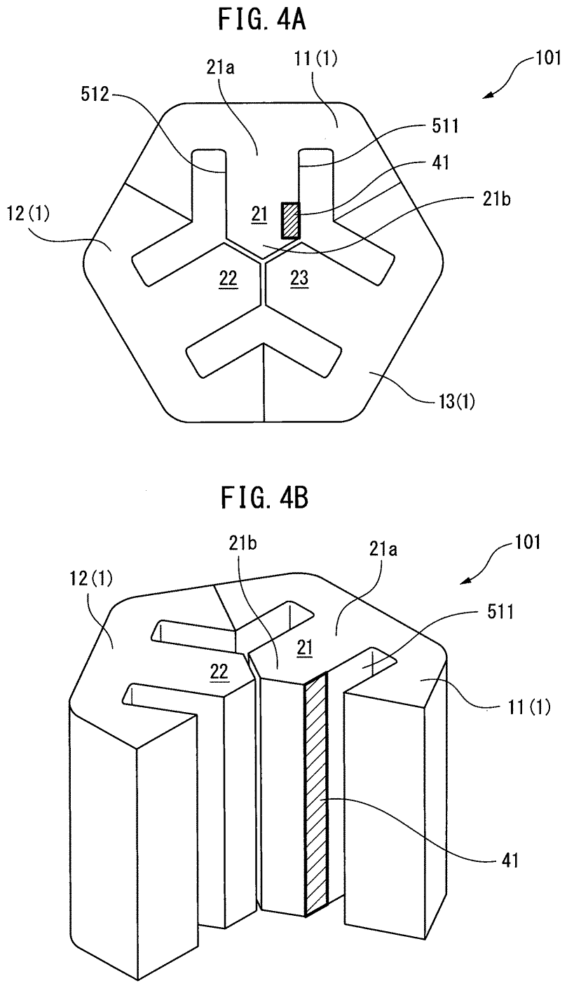

FIG. 4A is a plan view of the reactor 101 according to embodiment 1 of the present disclosure, and FIG. 4B is a perspective view of the reactor 101 according to embodiment 1 of the present disclosure. Note that in FIG. 4B, in order to facilitate understanding of the contents of the invention, the third outer peripheral iron core portion 13 and the third leg part iron core 23 have not been illustrated. The reactor 101 according to embodiment 1 is characterized by the feature wherein at least one (e.g., the first leg part iron core 21) of the three leg part iron cores (21, 22, 23) comprises a weld part 41 for welding at least a part of the plurality of electromagnetic steel sheets in the lamination direction AL (refer to FIG. 3). Note that in FIG. 4A, the hatched portion indicating the weld part 41 conceptually represents the portion in which welding is performed on the side surface 511, but does not reflect the actual depth of the weld part from the surface of side surface 511.

The weld part is preferably provided on a portion of the at least one leg part iron core that is located closer to the other end than the one end. For example, as shown in FIGS. 4A and 4B, the weld part 41 is preferably provided on a portion of the first leg part iron core 21 that is located closer to the other end 21b than the one end 21a. By providing the weld part in a position closer to the other end than the one end in the vicinity of the gap, vibration of the electromagnetic steel sheets can be effectively suppressed, since the vibration of the electromagnetic steel sheets constituting the leg part iron cores increases in the vicinity of the other ends, which are in the vicinity of the gaps.

In the reactor 101 according to embodiment 1, it is preferable that the leg part iron cores include two side surfaces arranged opposite each other in the circumferential direction, and that the weld part be provided on at least one of the side surfaces.

In FIG. 4B, the weld part 41 is provided along substantially all of the electromagnetic steel sheets in the lamination direction AL (refer to FIG. 3). However, the weld part 41 is not limited to such a configuration. In other words, the weld part 41 may be provided so as to weld a part of the plurality of electromagnetic steel sheets in the lamination direction AL.

According to the reactor according to embodiment 1, vibration of the electromagnetic steel sheets constituting the leg part iron cores, which is generated when the reactor is driven, can be suppressed.

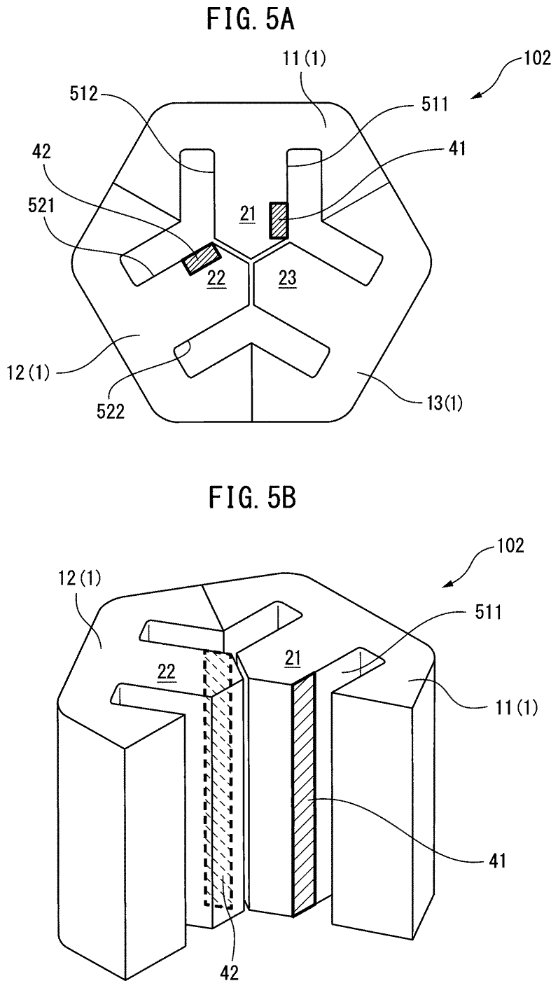

Then, a reactor according to embodiment 2 of the present disclosure will be described. FIG. 5A is a plan view of a reactor 102 according to embodiment 2 of the present disclosure, and FIG. 5B is a perspective view of the reactor 102 according to embodiment 2 of the present disclosure. Note that in FIG. 5B, in order to facilitate understanding of the contents of the invention, the third outer peripheral iron core portion 13 and the third leg part iron core 23 have not been illustrated. The reactor 102 according to embodiment 2 is characterized by the feature wherein the two leg part iron cores each have two side surfaces arranged opposite each other in the circumferential direction, and a weld part is provided on at least one of the two side surfaces of each of the two leg part iron cores. Note that since the structures other than the weld parts are the same as those of Example 1, detailed descriptions of the outer peripheral iron core, the leg part iron cores, and the coils have been omitted.

As shown in FIGS. 5A and 5B, the weld part 41 (hereinafter referred to as the “first weld part”) is provided on one side surface 511 of the two side surfaces (511, 512) of the first leg part iron core 21. Furthermore, the second weld part 42 is provided on one side surface 521 of the two side surfaces (521, 522) of the second leg part iron core 22. In FIG. 5B, the first weld part 41 and the second weld part 42 are provided along substantially all of the electromagnetic sheets in the lamination direction AL (refer to FIG. 3). However, the weld parts are not limited to such a configuration. In other words, the first weld part 41 and the second weld part 42 may be provided so as to weld a part of the plurality of electromagnetic steel sheets in the lamination direction AL.

By providing the first weld part 41 and the second weld part 42 on the one side surfaces (511, 521) of the two leg part iron cores (21, 22), respectively, the vibration suppression effect can be enhanced.

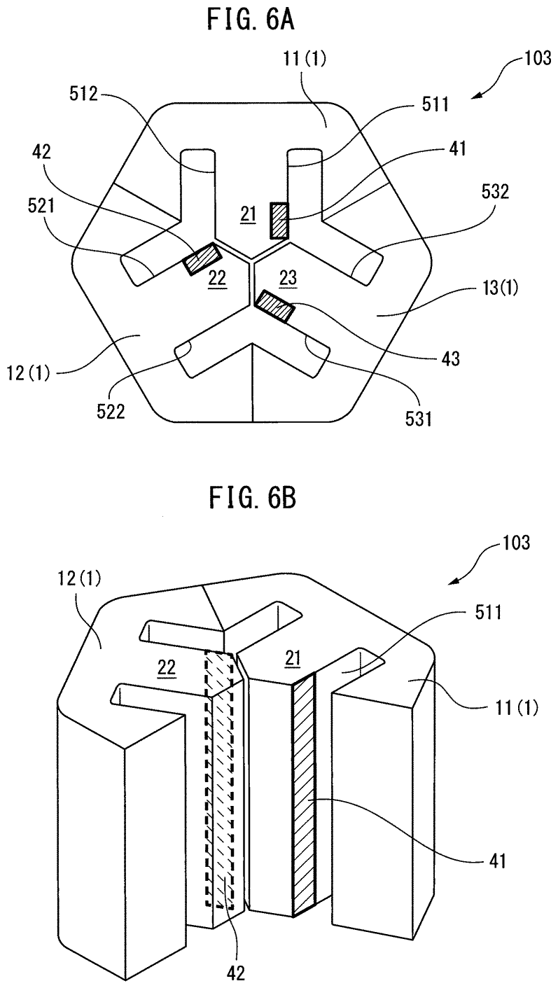

FIG. 6A is a plan view of a reactor 103 according to embodiment 3 of the present disclosure, and FIG. 6B is a perspective view of the reactor 103 according to embodiment 3 of the present disclosure. The reactor 103 according to embodiment 3 is characterized by the feature wherein the three leg part iron cores each have two side surfaces arranged opposite each other in the circumferential direction and a weld part is provided on one of the two side surfaces of each of the at least three leg part iron cores. Note that in FIG. 6B, in order to facilitate understanding of the contents of the invention, the third outer peripheral iron core portion 13 and the third leg part iron core 23 have not been illustrated.

As shown in FIGS. 6A and 6B, the first weld part 41 is provided on one side surface 511 of the two side surfaces (511, 512) of the first leg part iron core 2. Furthermore, the second weld part 42 is provided on one side surface 521 of the two side surfaces (521, 522) of the second leg part iron core 22. Further, the third weld part 43 is provided on one side surface 531 of the two side surfaces (531, 532) of the third leg part iron core 23. In FIG. 6B, the first weld part 41, the second weld part 42, and the third weld part 43 are provided along substantially all of the electromagnetic steel sheets in the lamination direction AL (refer to FIG. 3). However, the weld parts are not limited to such a configuration. In other words, the first weld part 41, the second weld part 42, and the third weld part 43 may be provided so as to weld a part of the plurality of electromagnetic steel sheets in the lamination direction AL.

By providing the first weld part 41, the second weld part 42, and the third weld part 43 on the one side surfaces (511, 521, 531) of the three leg part iron cores (21, 22, 23), respectively, the vibration suppression effect can be further enhanced.

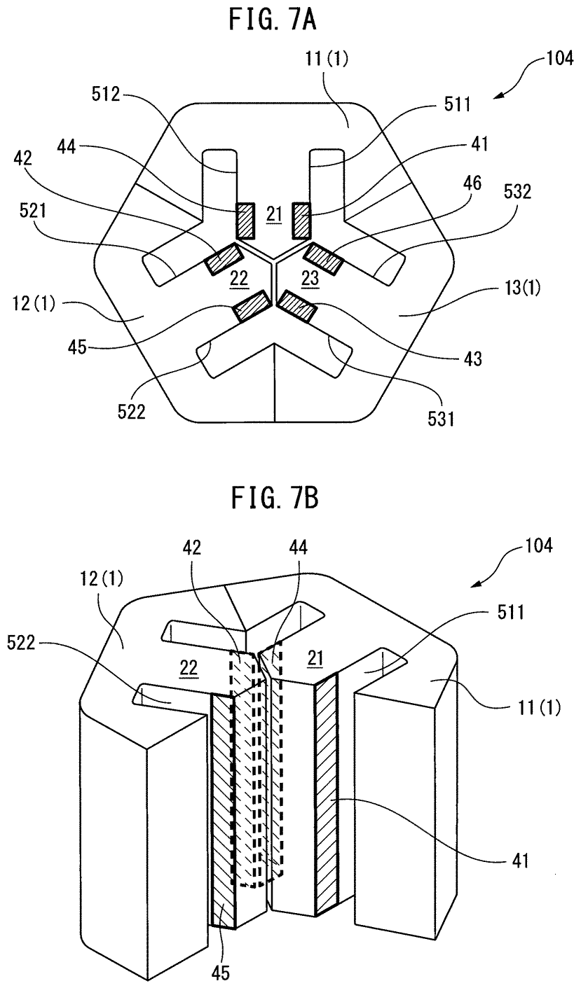

Then, a reactor according to embodiment 4 of the present disclosure will be described. FIG. 7A is a plan view of a reactor according to embodiment 4 of the present disclosure, and FIG. 7B is a perspective view of the reactor according to embodiment 4 of the present disclosure. Note that in FIG. 7B, in order to facilitate understanding of the contents of the invention, the third outer peripheral iron core portion 13 and the third leg part iron core 23 have not been illustrated. The reactor 104 according to embodiment 4 is characterized by the feature wherein weld parts are provided on both side surfaces.

In the example shown in FIGS. 7A and 7B, the first weld part 41 and the fourth weld part 44 are provided on both of the two side surfaces (511, 512) of the first leg part iron core 21. Furthermore, the second weld part 42 and the fifth weld part 45 are provided on both of the two side surfaces (521, 522) of the second leg part iron core 22. Further, the third weld part 43 and the sixth weld part 46 are provided on both of the two side surfaces (531, 532) of the third leg part iron core. In FIG. 7B, the first weld part 41, the second weld part 42, the fourth weld part 44 and the fifth weld part 45 are provided along substantially all of the electromagnetic steel sheets in the lamination direction AL (refer to FIG. 3). However, the weld parts are not limited to such a configuration. In other words, the first weld part 41, the second weld part 42, the fourth weld part 44, and the fifth weld part 45 may be provided so as to weld a part of the plurality of electromagnetic steel sheets in the lamination direction AL.

By providing weld parts on both of the two side surfaces of one leg part iron core in this manner, the vibration suppression effect can be enhanced as compared with the case in which a weld part is provided on only one side surface.

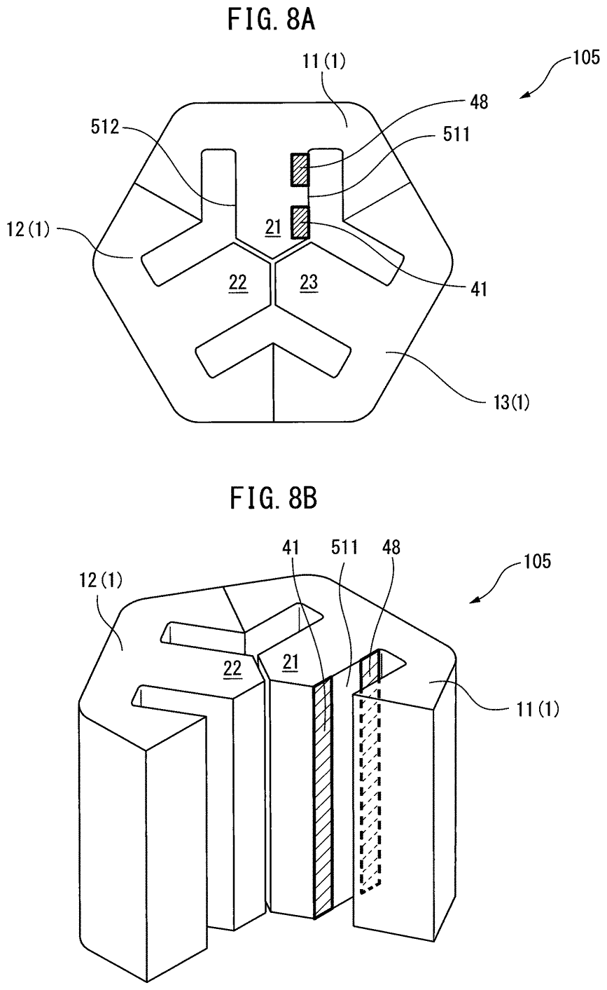

Then, a reactor according to embodiment 5 of the present disclosure will be described. FIG. 8A is a plan view of the reactor according to embodiment 5 of the present disclosure and FIG. 8B is a perspective view of the reactor according to embodiment 5 of the present disclosure. Note that in FIG. 8B, in order to facilitate understanding of the contents of the invention, the third outer peripheral iron core portion 13 and the third leg part iron core 23 have not been illustrated. The reactor 105 according to embodiment 5 is characterized by the feature wherein a plurality of weld parts are provided on the side surface of at least one leg part iron core.

In the example shown in FIGS. 8A and 8B, the first weld part 41 and the eighth weld part 48 are provided on one side surface 511 of the two side surfaces (511, 512) of the first leg part iron core 21. By providing a plurality of weld parts on one side surface, the electromagnetic steel sheets can be more firmly secured than in the case in which only one weld part is provided on one side surface, and vibration of the electromagnetic steel sheets when the reactor is driven can be further suppressed.

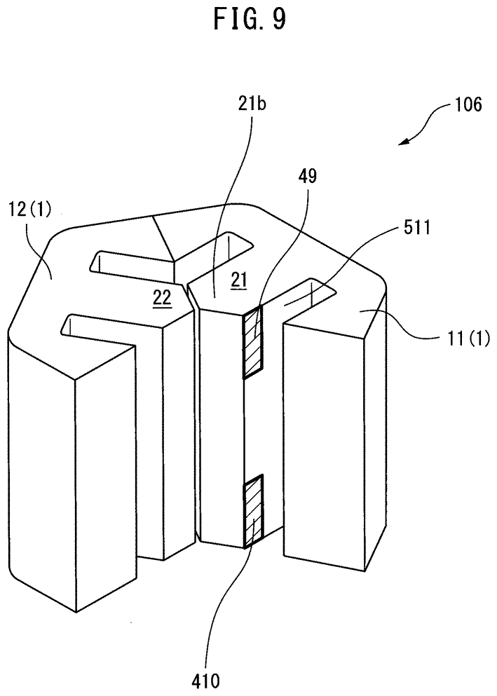

Then, a reactor according to embodiment 6 of the present disclosure will be described. FIG. 9 is a perspective view of the reactor according to embodiment 6 of the present disclosure. The reactor 106 according to embodiment 6 is characterized in that at least a portion of the weld part is provided in the vicinity of at least one of the ends of at least one side surface of at least one of the leg part iron cores in the lamination direction.

In the example shown in FIG. 9, the ninth weld part 49 is provided in the vicinity of the upper surface part, which is the one end, of the one side surface 511 of the first leg part iron core 21 in the lamination direction, and the tenth weld part 410 is provided in the vicinity of a bottom surface part, which is the other end in the lamination direction. By welding only a portion of the length of the laminate in this manner, cost can be reduced as compared to the case in which welding is carried out along all of the electromagnetic steel sheets in the lamination direction.

In the example shown in FIG. 9, the weld parts are provided on both the upper surface part and the bottom surface part of the side surface 511. However, the weld parts are not limited to such a configuration. A weld part may be provided on one of the upper surface part and the bottom surface part of the side surface 511. By providing a weld part on the upper surface part or the bottom surface part, vibration of the electromagnetic steel sheets when the reactor is driven can be effectively suppressed, since the vibration of the electromagnetic steel sheets when the reactor is driven is greatest in the upper surface parts and the bottom surface parts of the side surfaces.

Furthermore, it is preferable that weld parts be provided on the upper surface part or the bottom surface part of the side surfaces of a leg part iron core (e.g., the first leg part iron core 21) and in the vicinity (e.g., in the vicinity of the other end 21b) of the gap of the leg part iron core (e.g., the first leg part iron core 21), since the vibration of the electromagnetic steel sheets when the reactor is driven is greatest at the upper surface parts or bottom surface parts of the side surfaces of the leg part iron cores and in the vicinity of the gaps (in the vicinity of the other ends).

In embodiments 1 to 6 described above, it is preferable that the weld parts be formed by a laser welding method. According to a laser welding method, the stress generated in the leg part iron core due to heat can be reduced.

Alternatively, in embodiments 1 to 6 described above, the weld parts may be formed by a TIG welding method. According to a TIG welding method, manufacturing cost and equipment cost can be reduced as compared to the laser welding method.

In the reactors according to embodiments 1 to 6 described above, the number of the leg part iron cores and the coils is three. However, the number of the leg part iron cores and the coils may be four or more or may be a multiple of three.

The reactors according to embodiments 1 to 6 described above can be used as AC reactors or as DC reactors.

1. A reactor, comprising:
an outer peripheral iron core,
at least three leg part iron cores which are arrayed in the circumferential direction in a space on an inner surface side of the outer peripheral iron core, each of which is composed of a laminate of a plurality of electromagnetic steel sheets, and
coils wound on the respective at least three leg part iron cores, wherein
each of the at least three leg part iron cores is arranged so that one end thereof in the direction of a winding axis of the coil is magnetically connected to the outer peripheral iron core and the other end in the direction of the winding axis is magnetically connected to the other end of another of the at least three leg part iron cores via a gap, and
at least one of the leg part iron cores comprises a weld part for welding at least a part of the plurality of electromagnetic steel sheets in the lamination direction.

2. The reactor according to claim 1, wherein the weld part is provided on a portion of the at least one leg part iron core that is located closer to the other end than the one end.

3. The reactor according to claim 1, wherein the at least one leg part iron core includes two side surfaces arranged opposite each other in the circumferential direction, and
the weld part is provided on at least one of the side surfaces.

4. The reactor according to claim 3, wherein a plurality of the weld parts are provided on the side surface of the at least one leg part iron core.

5. The reactor according to claim 1, wherein at least a portion of the weld part is provided in the vicinity of at least one of the ends of at least one side surface of the at least one leg part iron core in the lamination direction.
